(19) United States
(12) Patent Application Publication
(10) Pub. No.: US 2014/0125601 A1
(43) Pub. Date: May 8, 2014

(54) TOUCH DISPLAY DEVICE

(71) Applicant: PRIMAX ELECTRONICS LTD., Taipei (TW)

(72) Inventors: Chung-Yuan Chen, Taipei (TW); Hsin-Yi Ho, Taipei (TW); Chun-Yu Lin, Taipei (TW)

(73) Assignee: PRIMAX ELECTRONICS LTD., Taipei (TW)

(21) Appl. No.: 13/689,957

(22) Filed: Nov. 30, 2012

(30) Foreign Application Priority Data
Nov. 6, 2012 (TW) 101141144

(51) Int. Cl. G06F 3/041

(52) U.S. Cl. CPC G06F 3/041
USPC 345/173

(57) ABSTRACT

A touch display device includes a display panel and a light guide board. The light guide board includes a light guide base, a touch-sensitive membrane, and a buffer layer. The touch-sensitive membrane is disposed on a first surface of the light guide base for sensing the positions of the user's fingers or other indicants. The buffer layer is arranged between the light guide base and the touch-sensitive membrane for separating said light guide base from the touch-sensitive membrane. Since the touch-sensitive membrane is disposed on the light guide base, it is not necessary to provide an additional plastic substrate to install the touch-sensitive membrane thereon. Consequently, the thickness of the touch display device can be reduced.

### FIELD OF THE INVENTION

The present invention relates to a touch display device, and more particularly to a touch display device with a light guide base and a touch-sensitive membrane, in which the touch-sensitive membrane is disposed on the light guide base.

### BACKGROUND OF THE INVENTION

Display devices are widely applied to various common electronic devices. For example, display devices may be used as the display screens of mobile phones, televisions, computers or other electronic devices in order display images or human-machine interaction interfaces. The images or the human-machine interaction interfaces shown on the display devices may facilitate the users to control the electronic devices. As known, if the human-machine interaction efficacy is enhanced, the user may operate the electronic device more intuitively. For enhancing the human-machine interaction efficacy, some kinds of display devices with touch-sensitive functions have been introduced into the markets. The display device with the touch-sensitive function is also referred as a touch display device. By touching the touch display device with fingers or other indicants, the user can easily operate the electronic device without the need of installing an additional human-machine interface device (e.g. a mouse or a keyboard).

A conventional touch display device comprises a protective plate, a touch-sensitive board, a light guide board, and a display panel. The protective plate is used as a topmost layer of the touch display device in order to protect the touch-sensitive board, the light guide board and the display panel from being damaged by foreign objects. The touch-sensitive board is disposed over the light guide board and the display panel for sensing the positions of the user's fingers or other indicants. Generally, the current touch-sensitive board is produced by performing a coating process or a screen printing process to form one or more electrode layers on a plastic substrate.

The light guide board is used for transferring a light beam in order to increase the luminance of the touch display device. The display panel is used for displaying an image or a human-machine interaction interface. Depending on the properties of the display panel, the light guide board may be disposed over the display panel (i.e. a front lighting design), or the light guide board may be disposed under the display panel (i.e. a back lighting design).

From the above discussions, the touch display device is produced by stacking plural plates or layers on each other. Since the plastic substrate of the touch-sensitive board has a specified thickness, after the touch-sensitive board is installed in the touch display device, the overall height of the touch display device is bound to be increased. In a case that the touch display device is applied to an electronic device, the increased height of the touch display device is detrimental to miniaturization of the electronic device. Under this circumstance, the market competitiveness of the electronic device is impaired.

### SUMMARY OF THE INVENTION

The present invention provides a slim-type touch display device.

In accordance with a first aspect of the present invention, there is provided a touch display device. The touch display device includes a display panel and a light guide board. The light guide board includes a light guide base, a touch-sensitive membrane, and a buffer layer. The light guide base is used for transferring a light beam. The touch-sensitive membrane is disposed on a first surface of the light guide base. The touch-sensitive membrane includes a first electrode layer, a second electrode layer and a spacer layer. The spacer layer is arranged between the first electrode layer and the second electrode layer. The buffer layer is arranged between the light guide base and the touch-sensitive membrane for separating the light guide base from the touch-sensitive membrane.

In an embodiment, the display panel is a liquid crystal panel.

In an embodiment, the display panel is an electronic paper panel.

In an embodiment, the first electrode layer and the second electrode layer are made of carbon nanotubes.

In an embodiment, the first electrode layer and the second electrode layer are made of nano silver.

In an embodiment, the first surface of the light guide base is a top surface of the light guide base.

In an embodiment, the first surface of the light guide base is a bottom surface of the light guide base.

In an embodiment, the touch display device further includes a light source, and the light source is located at a side of the light guide base.

In an embodiment, a refractive index of the buffer layer is in a range between 1 and a refractive index of the light guide base.

In an embodiment, the buffer layer is made of an optical clear adhesive (OCA) or an optical clear resin (OCR).

In an embodiment, the touch display device further includes a protective plate.

In an embodiment, the protective plate includes a plastic substrate and an anti-glare film.

In an embodiment, the light guide board is disposed over the display panel.

In an embodiment, the light guide board is disposed under the display panel.

In an embodiment, the touch display device further includes a reflector. The reflector is disposed under the light guide board.

In an embodiment, the light guide board further includes a microstructural layer. The microstructural layer microstructural layer is disposed on a second surface of the light guide base. The second surface of the light guide base is opposed to the first surface of the light guide base.

In an embodiment, the microstructural layer is made of a UV-curable paint.

In an embodiment, the microstructural layer is formed on the second surface of the light guide base by a hot embossing process.

In accordance with a second aspect of the present invention, there is provided a touch display device. The touch display device includes a protective plate, a display panel, a light guide board, and a light source. The display panel is disposed under the protective plate. The light guide board is arranged between the protective plate and the display panel. The light guide board includes a light guide base, a touch-sensitive membrane, a buffer layer, and a microstructural layer. The light guide base is used for transferring a light beam. The touch-sensitive membrane is disposed on a top surface of the light guide base. The touch-sensitive membrane includes a first electrode layer, a second electrode layer and a spacer layer. The spacer layer is arranged between the first electrode layer and the second electrode layer. The buffer layer is arranged between the light guide base and the touch-sensitive membrane for separating the light guide base from the touch-sensitive membrane. The microstructural layer is disposed on a bottom surface of the light guide base. The light source is located at a side of the light guide base.

In an embodiment, the display panel is a liquid crystal panel.

In an embodiment, the display panel is an electronic paper panel.

In an embodiment, the first electrode layer and the second electrode layer are made of carbon nanotubes.

In an embodiment, the first electrode layer and the second electrode layer are made of nano silver.

In an embodiment, a refractive index of the buffer layer is in a range between 1 and a refractive index of the light guide base.

In an embodiment, the buffer layer is made of an optical clear adhesive (OCA) or an optical clear resin (OCR).

In an embodiment, the protective plate includes a plastic substrate and an anti-glare film.

In an embodiment, the microstructural layer is made of a UV-curable paint.

In an embodiment, the microstructural layer is formed on the bottom surface of the light guide base by a hot embossing process.

In accordance with a third aspect of the present invention, there is provided a touch display device. The touch display device includes a protective plate, a display panel, a light guide board, and a light source. The display panel is disposed under the protective plate. The light guide board is disposed under the protective plate. The light guide board includes a light guide base, a touch-sensitive membrane, a buffer layer, and a microstructural layer. The light guide base is used for transferring a light beam. The touch-sensitive membrane is disposed on a bottom surface of the light guide base. The touch-sensitive membrane includes a first electrode layer, a second electrode layer and a spacer layer. The spacer layer is arranged between the first electrode layer and the second electrode layer. The buffer layer is arranged between the light guide base and the touch-sensitive membrane for separating the light guide base from the touch-sensitive membrane. The microstructural layer is disposed on a top surface of the light guide base. The light source is located at a side of the light guide base.

In an embodiment, the display panel is a liquid crystal panel.

In an embodiment, the display panel is an electronic paper panel.

In an embodiment, the first electrode layer and the second electrode layer are made of carbon nanotubes.

In an embodiment, the first electrode layer and the second electrode layer are made of nano silver.

In an embodiment, a refractive index of the buffer layer is in a range between 1 and a refractive index of the light guide base.

In an embodiment, the buffer layer is made of an optical clear adhesive (OCA) or an optical clear resin (OCR).

In an embodiment, the protective plate includes a plastic substrate and an anti-glare film.

In an embodiment, the microstructural layer is made of a UV-curable paint.

In an embodiment, the microstructural layer is formed on the top surface of the light guide base by a hot embossing process.

In accordance with a fourth aspect of the present invention, there is provided a touch display device. The touch display device includes a protective plate, a display panel, a light guide board, a light source, and a reflector. The display panel is disposed under the protective plate. The light guide board is disposed under the protective plate. The light guide board includes a light guide base, a touch-sensitive membrane, a buffer layer, and a microstructural layer. The light guide base is used for transferring a light beam. The touch-sensitive membrane is disposed on a top surface of the light guide base. The touch-sensitive membrane includes a first electrode layer, a second electrode layer and a spacer layer. The spacer layer is arranged between the first electrode layer and the second electrode layer. The buffer layer is arranged between the light guide base and the touch-sensitive membrane for separating the light guide base from the touch-sensitive membrane. The microstructural layer is disposed on a bottom surface of the light guide base. The light source is located at a side of the light guide base. The reflector is disposed under the light guide board.

In an embodiment, the display panel is a liquid crystal panel.

In an embodiment, the first electrode layer and the second electrode layer are made of carbon nanotubes.

In an embodiment, the first electrode layer and the second electrode layer are made of nano silver.

In an embodiment, a refractive index of the buffer layer is in a range between 1 and a refractive index of the light guide base.

In an embodiment, the buffer layer is made of an optical clear adhesive (OCA) or an optical clear resin (OCR).

In an embodiment, the protective plate includes a plastic substrate and an anti-glare film.

In an embodiment, the microstructural layer is made of a UV-curable paint.

In an embodiment, the microstructural layer is formed on the bottom surface of the light guide base by a hot embossing process.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the components of a touch display device according to a first embodiment of the present invention;

FIG. 2 schematically illustrates the components of a touch display device according to a second embodiment of the present invention; and

FIG. 3 schematically illustrates the components of a touch display device according to a third embodiment of the present invention.

### DETAILED DESCRIPTION OF THE PREFERRED EMBODIMENT

The present invention provides a touch display device. The touch display device may be applied to a display screen of an electronic device (e.g. a mobile phone, a television or a computer) in order to display an image or a human-machine interaction interface. In addition, the touch display device has a touch-sensitive function.

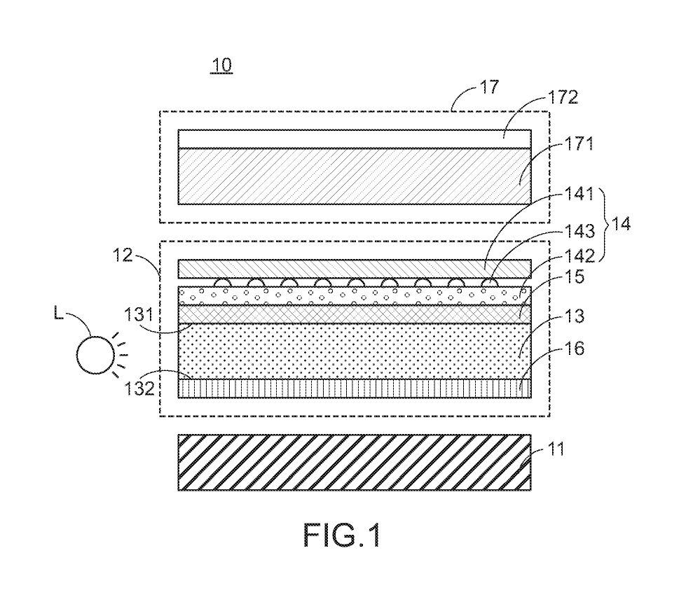

Hereinafter, a touch display device according to a first embodiment of the present invention will be illustrated with reference to FIG. 1. FIG. 1 schematically illustrates the components of a touch display device according to a first embodiment of the present invention. As shown in FIG. 1, the touch display device 10 comprises a light source L, a display panel 11, and a light guide board 12. The light source L is used for emitting a light beam. The display panel 11 is used for displaying an image or a human-machine interaction interface. The light guide board 12 is used for transferring the light beam and implementing the touch-sensitive function.

An example of the display panel 11 includes but is not limited to a liquid crystal panel or an electronic paper panel. Depending on the properties of the display panel, the light guide board 12 may be disposed over the display panel 11 or under the display panel 11. In this embodiment, the display panel 11 is a light-transmissible panel or an opaque panel. Moreover, in this embodiment, the light guide board 12 is disposed over the display panel 11 (i.e. a front lighting design).

Please refer to FIG. 1 again. As shown in FIG. 1, the light guide board 12 comprises a light guide base 13, a touch-sensitive membrane 14, and a buffer layer 15. The touch-sensitive membrane 14 comprises a first electrode layer 141, a second electrode layer 142 and a spacer layer 143. In this embodiment, the light source L is located at a side of the light guide base 13. The light guide base 13 is used for transferring the light beam that is emitted by the light source L. For example, the light source L is a light emitting diode (LED). The light guide base 13 is made of a transparent material. An example of the transparent material includes but is not limited to polycarbonate (PC), polyethylene terephthalate (PET) or silicone resin.

The touch-sensitive membrane 14 is disposed on a first surface 131 of the light guide base 13 for sensing the positions of the user's fingers or other indicants. The spacer layer 143 is arranged between the first electrode layer 141 and the second electrode layer 142. Due to the spacer layer 143, the first electrode layer 141 and the second electrode layer 142 are separated from each other and electrically isolated from each other. It is noted that the first surface 131 of the light guide base 13 is not restricted to a top surface of the light guide base 13 or a bottom surface of the light guide base 13. In this embodiment, the touch-sensitive membrane 14 is disposed on the top surface of the light guide base 13.

The touch-sensitive membrane 14 may be formed on the first surface 131 of the light guide base 13 by a screen printing process, but is not limited thereto. Moreover, the touch-sensitive membrane 14 may be a resistive touch-sensitive membrane or a capacitive touch-sensitive membrane. Moreover, the first electrode layer 141 and the second electrode layer 142 are made of carbon nanotubes or nano silver, but are not limited thereto.

Depending on the properties of the touch-sensitive membrane and/or the relative position between the light guide board and the display panel, the type of the touch-sensitive membrane may be varied. For example, in a case that the light guide board 12 is disposed over the display panel 11, the touch-sensitive membrane 14 may be a resistive touch-sensitive membrane or a capacitive touch-sensitive membrane. Whereas, in a case that the light guide board 12 is disposed under the display panel 11, the capacitive touch-sensitive membrane is suitably used as the touch-sensitive membrane 14 because the display panel 11 is inflexible.

The buffer layer 15 is arranged between the light guide base 13 and the touch-sensitive membrane 14 for separating the light guide base 13 from the touch-sensitive membrane 14. Due to the buffer layer 15, the light beam within the light guide base 13 is subject to total internal reflection and transferred within the light guide base 13. In addition, the light beam is not absorbed by the touch-sensitive membrane 14. The touch-sensitive membrane 14 may be formed on the first surface 131 of the light guide base 13 by a screen printing process, but is not limited thereto. Moreover, it is preferred that the buffer layer 15 is made of a material with low absorptivity and low emissivity to the light beam. Due to the low absorptivity and low emissivity, the adverse influence of the buffer layer 15 on the light-transferring efficacy of the light guide base 13 will be minimized.

According to the principle of the total internal reflection of light, the refractive index of the buffer layer 15 should be lower than the refractive index of the light guide base 13 in order to assure that the light beam within the light guide base 13 is possibly subject to the total internal reflection. In a case that the light guide base 13 is made of polycarbonate, the refractive index of the buffer layer 15 should be in the range between 1 (i.e. the refractive index of air) and 1.5872 (i.e. the refractive index of polycarbonate).

If the refractive index of the buffer layer 15 is closer to 1, the ratio between the refractive index of the buffer layer 15 and the refractive index of the light guide base 13 is smaller. Under this circumstance, the critical angle for resulting in the total internal reflection becomes smaller, and thus the light beam is subject to the total internal reflection more easily. In other words, if the refractive index of the buffer layer 15 is closer to the refractive index of air, the efficacy of transferring the light beam by the light guide base 13 is enhanced. Preferably, the buffer layer 15 is made of an optical clear adhesive (OCA) or an optical clear resin (OCR), but is not limited thereto.

In order to increase the luminance of the display panel 11, the light beam within the light guide base 13 should be effectively transmitted through the light guide base 13. For achieving this purpose, the light guide board 12 further comprises a microstructural layer 16. The microstructural layer 16 is presented herein for purpose of illustration and description only. In this embodiment, the microstructural layer 16 is disposed on a second surface 132 of the light guide base 13. The second surface 132 of the light guide base 13 is opposed to the first surface 131 of the light guide base 13.

In this embodiment, the first surface 131 of the light guide base 13 is the top surface of the light guide base 13. In other words, the second surface 132 of the light guide base 13 is the bottom surface of the light guide base 13. Moreover, the microstructural layer 16 is formed on the second surface 132 of the light guide base 13 by coating a UV-curable paint, or the microstructural layer 16 is formed on the second surface 132 of the light guide base 13 by a hot embossing process. The way of forming the microstructural layer 16 is presented herein for purpose of illustration and description only.

For protecting the display panel 11 and the light guide board 12 from being damaged by foreign objects, the touch display device 10 further comprises a protective plate 17, but is not limited thereto. The protective plate 17 is used as the topmost layer of the touch display device 10. In this embodiment, the protective plate 17 comprises a plastic substrate 171 and an anti-glare film 172. The plastic substrate 171 is used for preventing the foreign objects from being directly contacted with the display panel 11 or the light guide board 12. The anti-glare film 172 is disposed on the plastic substrate 171 for achieving the anti-glare efficacy.

Moreover, different plates or boards of the touch display device 10 (e.g. the display panel 11 and the light guide board 12, or the light guide board 12 and the protective plate 17) may be combined together via an adhesive such as an optical clear adhesive (OCA) or an optical clear resin (OCR), but is not limited thereto.

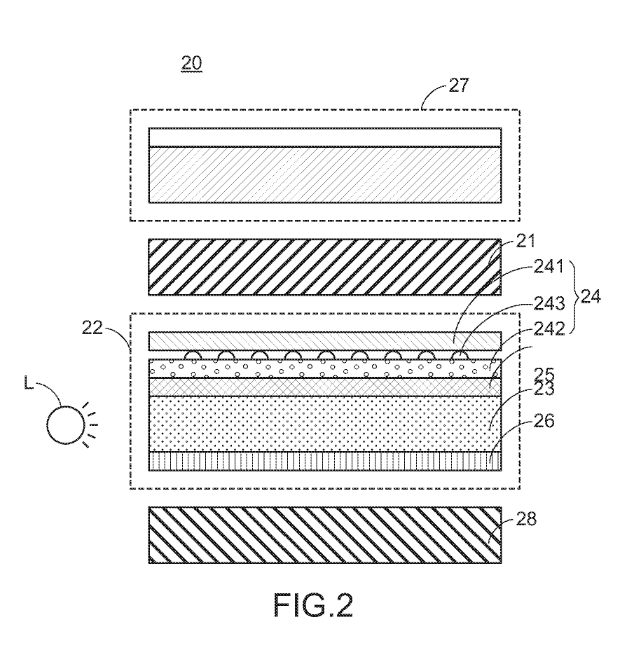

Hereinafter, a touch display device according to a second embodiment of the present invention will be illustrated with reference to FIG. 2. FIG. 2 schematically illustrates the components of a touch display device according to a second embodiment of the present invention. As shown in FIG. 2, the touch display device 20 comprises a light source L, a display panel 21, a light guide board 22, and a protective plate 27. The light guide board 22 comprises a light guide base 23, a touch-sensitive membrane 24, a buffer layer 25, and a microstructural layer 26. The touch-sensitive membrane 24 comprises a first electrode layer 241, a second electrode layer 242 and a spacer layer 243.

In comparison with the first embodiment of FIG. 1, the touch display device 20 of this embodiment has a back lighting design. The configurations of the other components of the touch display device 20 are substantially identical to those of the touch display device 10 of the first embodiment, and are not redundantly described herein. It is noted that only the light-transmissible panel (e.g. a liquid crystal panel) is suitably used as the display panel of the back-lighting touch display device. If the opaque panel is used as the display panel of the back-lighting touch display device, the light beam is unable to be transmitted through the opaque panel, and thus the luminance of the display panel 21 fails to be increased.

In this embodiment, as shown in FIG. 2, the display panel 21 is a light-transmissible panel. In addition, since the light guide board 22 is disposed under the display panel 21, the touch display device 20 has a back lighting design. In the back lighting design, the touch display device 20 may further comprise a reflector 28. The reflector 28 is disposed under the light guide board 22 for increasing the reflectivity of the light beam, so that the luminance of the display panel 21 is enhanced.

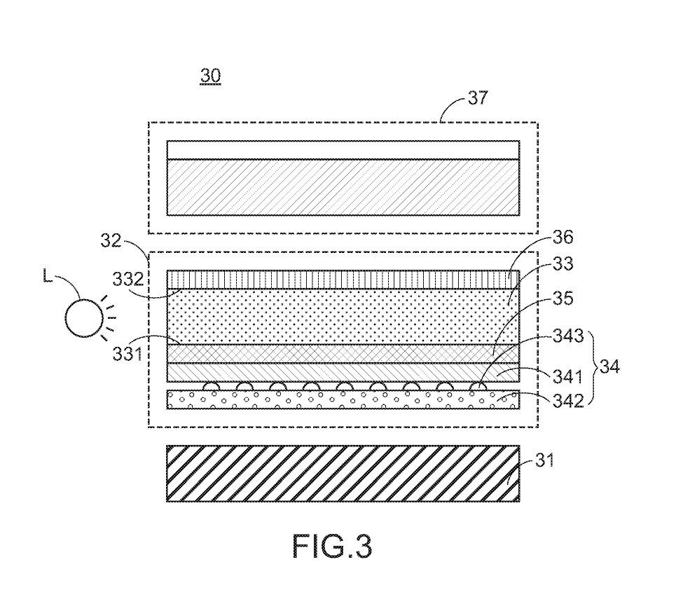

Hereinafter, a touch display device according to a third embodiment of the present invention will be illustrated with reference to FIG. 3. FIG. 3 schematically illustrates the components of a touch display device according to a third embodiment of the present invention. As shown in FIG. 3, the touch display device 30 comprises a light source L, a display panel 31, a light guide board 32, and a protective plate 37. The light guide board 32 comprises a light guide base 33, a touch-sensitive membrane 34, a buffer layer 35, and a microstructural layer 36. The touch-sensitive membrane 34 comprises a first electrode layer 341, a second electrode layer 342 and a spacer layer 343.

Except that the first surface 331 of the light guide base 33 is the bottom surface of the light guide base 33 and the second surface 332 of the light guide base 33 is the top surface of the light guide base 33, the configurations of the other components of the touch display device 30 are substantially identical to those of the touch display device 10 of the first embodiment, and are not redundantly described herein.

Please refer to FIG. 3 again. The touch-sensitive membrane 34 is disposed on the first surface 331 of the light guide base 33. In this embodiment, the touch-sensitive membrane 34 is disposed on the bottom surface of the light guide base 33. The buffer layer 35 is arranged between the light guide base 33 and the touch-sensitive membrane 34 for separating the light guide base 33 from the touch-sensitive membrane 34. Due to the buffer layer 35, the light beam is not absorbed by the touch-sensitive membrane 34. Whereas, the light beam is transferred within the light guide base 33 according to the total internal reflection. Moreover, the microstructural layer 36 is disposed on the top surface of the light guide base 33. Through the microstructural layer 36, the light beam within the light guide base 33 can be outputted from the light guide base 33.

From the above descriptions, the present invention provides a touch display device. The touch display device comprises a display panel and a light guide board. The light guide board includes a light guide base, a touch-sensitive membrane, and a buffer layer. Moreover, the touch-sensitive membrane is disposed on a first surface of the light guide base for sensing the positions of the user's fingers or other indicants. The buffer layer is arranged between the light guide base and the touch-sensitive membrane for separating the light guide base from the touch-sensitive membrane. In accordance with the present invention, the touch-sensitive membrane is disposed on the light guide base to achieve the touch-sensitive function of the touch display device without the need of installing an additional plastic substrate. Under this circumstance, since the overall height of the touch display device can be further reduced, the touch display device becomes slim.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A touch display device, comprising:
a display panel; and
a light guide board comprising:
a light guide base for transferring a light beam;
a touch-sensitive membrane disposed on a first surface of said light guide base, wherein said touch-sensitive membrane comprises a first electrode layer, a second electrode layer and a spacer layer, wherein said spacer layer is arranged between said first electrode layer and said second electrode layer; and
a buffer layer arranged between said light guide base and said touch-sensitive membrane for separating said light guide base from said touch-sensitive membrane.

2. The touch display device according to claim 1, wherein said display panel is a liquid crystal panel.

3. The touch display device according to claim 1, wherein said display panel is an electronic paper panel.

4. The touch display device according to claim 1, wherein said first electrode layer and said second electrode layer are made of carbon nanotubes.

5. The touch display device according to claim 1, wherein said first electrode layer and said second electrode layer are made of nano silver.

6. The touch display device according to claim 1, wherein said first surface of said light guide base is a top surface of said light guide base.

7. The touch display device according to claim 1, wherein said first surface of said light guide base is a bottom surface of said light guide base.

8. The touch display device according to claim 1, wherein said touch display device further comprises a light source, and said light source is located at a side of said light guide base.

9. The touch display device according to claim 1, wherein a refractive index of said buffer layer is in a range between 1 and a refractive index of said light guide base.

10. The touch display device according to claim 1, wherein said buffer layer is made of an optical clear adhesive (OCA) or an optical clear resin (OCR).

11. The touch display device according to claim 1, wherein said touch display device further comprises a protective plate.

12. The touch display device according to claim 11, wherein said protective plate comprises a plastic substrate and an anti-glare film.

13. The touch display device according to claim 1, wherein said light guide board is disposed over said display panel.

14. The touch display device according to claim 1, wherein said light guide board is disposed under said display panel.

15. The touch display device according to claim 14, further comprising a reflector, which is disposed under said light guide board.

16. The touch display device according to claim 1, wherein said light guide board further comprises a microstructural layer, which is disposed on a second surface of said light guide base, wherein said second surface of said light guide base is opposed to said first surface of said light guide base.

17. The touch display device according to claim 16, wherein said microstructural layer is made of a UV-curable paint.

18. The touch display device according to claim 16, wherein said microstructural layer is formed on said second surface of said light guide base by a hot embossing process.

19. A touch display device, comprising:
a protective plate;
a display panel disposed under said protective plate;
a light guide board arranged between said protective plate and said display panel, and comprising:
a light guide base for transferring a light beam;
a touch-sensitive membrane disposed on a top surface of said light guide base, wherein said touch-sensitive membrane comprises a first electrode layer, a second electrode layer and a spacer layer, wherein said spacer layer is arranged between said first electrode layer and said second electrode layer;
a buffer layer arranged between said light guide base and said touch-sensitive membrane for separating said light guide base from said touch-sensitive membrane; and
a microstructural layer disposed on a bottom surface of said light guide base; and
a light source located at a side of said light guide base.

20. The touch display device according to claim 19, wherein said display panel is a liquid crystal panel.

21. The touch display device according to claim 19, wherein said display panel is an electronic paper panel.

22. The touch display device according to claim 19, wherein said first electrode layer and said second electrode layer are made of carbon nanotubes.

23. The touch display device according to claim 19, wherein said first electrode layer and said second electrode layer are made of nano silver.

24. The touch display device according to claim 19, wherein a refractive index of said buffer layer is in a range between 1 and a refractive index of said light guide base.

25. The touch display device according to claim 19, wherein said buffer layer is made of an optical clear adhesive (OCA) or an optical clear resin (OCR).

26. The touch display device according to claim 19, wherein said protective plate comprises a plastic substrate and an anti-glare film.

27. The touch display device according to claim 19, wherein said microstructural layer is made of a UV-curable paint.

28. The touch display device according to claim 19, wherein said microstructural layer is formed on said bottom surface of said light guide base by a hot embossing process.

29. A touch display device, comprising:
a protective plate;
a display panel disposed under said protective plate;
a light guide board disposed under said protective plate, and comprising:
a light guide base for transferring a light beam;
a touch-sensitive membrane disposed on a bottom surface of said light guide base, wherein said touch-sensitive membrane comprises a first electrode layer, a second electrode layer and a spacer layer, wherein said spacer layer is arranged between said first electrode layer and said second electrode layer;
a buffer layer arranged between said light guide base and said touch-sensitive membrane for separating said light guide base from said touch-sensitive membrane; and
a microstructural layer disposed on a top surface of said light guide base; and
a light source located at a side of said light guide base.

30. The touch display device according to claim 29, wherein said display panel is a liquid crystal panel.

31. The touch display device according to claim 29, wherein said display panel is an electronic paper panel.

32. The touch display device according to claim 29, wherein said first electrode layer and said second electrode layer are made of carbon nanotubes.

33. The touch display device according to claim 29, wherein said first electrode layer and said second electrode layer are made of nano silver.

34. The touch display device according to claim 29, wherein a refractive index of said buffer layer is in a range between 1 and a refractive index of said light guide base.

35. The touch display device according to claim 29, wherein said buffer layer is made of an optical clear adhesive (OCA) or an optical clear resin (OCR).

36. The touch display device according to claim 29, wherein said protective plate comprises a plastic substrate and an anti-glare film.

37. The touch display device according to claim 29, wherein said microstructural layer is made of a UV-curable paint.

38. The touch display device according to claim 29, wherein said microstructural layer is formed on said top surface of said light guide base by a hot embossing process.

39. A touch display device, comprising:
a protective plate;
a display panel disposed under said protective plate;
a light guide board disposed under said protective plate, and comprising:
a light guide base for transferring a light beam;
a touch-sensitive membrane disposed on a top surface of said light guide base, wherein said touch-sensitive membrane comprises a first electrode layer, a second electrode layer and a spacer layer, wherein said spacer layer is arranged between said first electrode layer and said second electrode layer;
a buffer layer arranged between said light guide base and said touch-sensitive membrane for separating said light guide base from said touch-sensitive membrane; and
a microstructural layer disposed on a bottom surface of said light guide base;
a light source located at a side of said light guide base; and
a reflector disposed under said light guide board.

40. The touch display device according to claim 39, wherein said display panel is a liquid crystal panel.

41. The touch display device according to claim 39, wherein said first electrode layer and said second electrode layer are made of carbon nanotubes.

42. The touch display device according to claim 39, wherein said first electrode layer and said second electrode layer are made of nano silver.

43. The touch display device according to claim 39, wherein a refractive index of said buffer layer is in a range between 1 and a refractive index of said light guide base.

44. The touch display device according to claim 39, wherein said buffer layer is made of an optical clear adhesive (OCA) or an optical clear resin (OCR).

45. The touch display device according to claim 39, wherein said protective plate comprises a plastic substrate and an anti-glare film.

46. The touch display device according to claim 39, wherein said microstructural layer is made of a UV-curable paint.

47. The touch display device according to claim 39, wherein said microstructural layer is formed on said bottom surface of said light guide base by a hot embossing process.
